(19) United States
(12) Patent Application Publication
(10) Pub. No.: US 2018/0039928 A1
(43) Pub. Date: Feb. 8, 2018

(54) METHOD AND SYSTEM FOR AUTO-SELECTION OF EMPLOYEES FOR TRAININGS IN AN ORGANIZATION

(71) Applicant: XEROX CORPORATION, Norwalk, CT (US)

(72) Inventors: Atul Singh, Bangalore (IN); Arpit Jain, Bangalore (IN); Rahul Ghosh, Bangalore (IN); Jagadeesh Chandra Bose Rantham Prabhakara, Chittoor (IN); Gurulingesh Raravi, Bangalore (IN); Preethy Varma, Cochin (IN); Koustuv Dasgupta, Bangalore (IN)

(21) Appl. No.: 15/227,123

(22) Filed: Aug. 3, 2016

(51) Int. Cl. G06Q 10/06; G09B 5/08

(52) U.S. Cl. CPC G06Q 10/063112; G06Q 10/06313; G09B 5/08

(57) ABSTRACT

A method and a system are provided for role-based auto-selection of employees for trainings associated with skills required in a project. The method comprising receiving a request for the project. The method may extract one or more current skills of one or more employees based on the received request. The method for a required role in a project may further determine, a proficiency gap between the one or more required skills and the one or more current skills for each of the one or more employees. The method for a required role in a project may prioritize the one or more required skills for each of the one or more employees based on the determined proficiency gap. The method may select a set of employees from the one or more employees for one or more skill-based trainings.

### TECHNICAL FIELD

The presently disclosed embodiments are related, in general, to human resource management systems. More particularly, the presently disclosed embodiments are related to a method and a system for a role-based auto-selection of one or more employees for one or more trainings associated with one or more skills required in a project.

### BACKGROUND

Recently, globalized markets and emerging competition have motivated organizations to organize their multifold divisions into smaller units. Consequently, organizations are now quite keen on optimizing various resources to avail cost-related benefits while considering new business opportunities and technical needs that are changing quickly. Increasingly, an organization's ability to achieve its goals depends not only on proper planning and its implementation, but also on whether the organization is able to acquire appropriate skills, and define associated levels to achieve the set goals and objectives. The planning and implementation of resource strategies, to achieve cost-related benefits, have become increasingly important for effective utilization of available resources in organizations. Further, organizations are developing accurate profiles of associated resources and related parameters for specific emerging roles. So, to ensure that resources are prepared and adequately trained, management of organizations may need to determine what needs to be done for dynamic requirements that may arise in future.

Generally, the management may utilize ad-hoc techniques, personal judgment, and experience to identify skill gaps of various resources in the organization. However, such identification may be erroneous and inaccurate, leading to either over- or under-estimation of the skill gaps. Further, if a resource is found lacking in one of the key skills, then there is no way for the management to predict if a training on the skill will help improve the performance of the resource. Thus, there is a need for a method and system that may be useful for efficient planning and implementing of resource strategies so that that the resources are adequately trained.

Further limitations and disadvantages of conventional and traditional approaches will become apparent to a person having ordinary skill in the art, through a comparison of described systems with some aspects of the present disclosure, as set forth in the remainder of the present application and with reference to the drawings.

### SUMMARY

According to embodiments illustrated herein, there may be provided a method for role-based auto-selection of employees for trainings associated with skills required in a project. The method may comprise receiving, by one or more transceivers at a server, a request for the project from a requestor computing device over a communication network. The request may comprise at least one or more required skills for one or more required roles in the project. The method may further comprise extracting, by one or more processors at the server, one or more attributes of one or more employees from a database server based on the received request. The one or more attributes may comprise at least one or more current skills of the one or more employees. The method, for a required role in the project, may further comprise determining, by the one or more processors at the server, a proficiency gap between the one or more required skills and the one or more current skills for each of the one or more employees based on a historical data associated with said each of the one or more employees. The method, for the required role in the project, may further comprise prioritizing, by the one or more processors at the server, the one or more required skills for each of the one or more employees based on the determined proficiency gap. The method may further comprise selecting, by the one or more processors at the server, a set of employees from the one or more employees for one or more skill-based trainings, associated with the one or more required skills, based on at least the prioritized one or more required skills associated with the one or more required roles.

According to embodiments illustrated herein, there may be provided a system for role-based auto-selection of employees for trainings associated with skills required in a project. The system may comprise one or more transceiver that are configured to receive a request for the project from a requestor computing device over a communication network. The request may comprise at least one or more required skills for a required role in the project. The system may further comprise one or more processors that are configured to extract one or more attributes of one or more employees from a database server based on the received request. The one or more attributes may comprise at least one or more current skills of the one or more employees. For the required role in the project, the one or more processors are further configured to determine a proficiency gap between the one or more required skills and the one or more current skills for each of the one or more employees based on a historical data associated with each of the one or more employees. For the required role in the project, the one or more processors are further configured to prioritize the one or more required skills for each of the one or more employees based on the determined proficiency gap. The one or more processors may further be configured to select a set of employees from the one or more employees for one or more skill-based trainings, associated with the one or more required skills, based on at least the prioritized one or more required skills associated with the required role.

According to embodiments illustrated herein, there may be provided a computer program product for use with a computing device. The computer program product comprises a non-transitory computer readable medium storing a computer program code for role-based auto-selection of employees for trainings associated with skills required in a project. The computer program code is executable by one or more processors to receive a request for the project from a requestor computing device over a communication network. The request comprises at least one or more required skills for one or more required roles in the project. The computer program code is further executable by the one or more processors to extract one or more attributes of one or more employees from a database server based on the received request. The one or more attributes comprise at least one or more current skills of the one or more employees. The computer program code is further executable by the one or more processors to determine a proficiency gap between the one or more required skills and the one or more current skills for each of the one or more employees based on a historical data associated with said each of the one or more employees. The computer program code is further executable by the one or more processors to prioritize the one or more required skills for each of the one or more employees based on the determined proficiency gap. The computer program code is further executable by the one or more processors to select a set of employees from the one or more employees for one or more skill-based trainings, associated with the one or more required skills, based on at least the prioritized one or more required skills associated with the one or more required roles.

### BRIEF DESCRIPTION OF DRAWINGS

The accompanying drawings illustrate the various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not limit the scope in any manner, wherein similar designations denote similar elements, and in which:

FIG. 1 is a block diagram that illustrates a system environment in which various embodiments may be implemented, in accordance with at least one embodiment;

FIG. 2 is a block diagram that illustrates a computing server configured for role-based auto-selection of employees for skill-based trainings, in accordance with at least one embodiment;

FIG. 3 is a flowchart that illustrates a method for role-based auto-selection of employees for skill-based trainings, in accordance with at least one embodiment;

FIG. 4 is a flow diagram that illustrates ontology of an organization, in accordance with at least one embodiment; and

FIG. 5 is a block diagram that illustrates an exemplary graphical user interface (GUI) for role-based auto-selection of employees for skill-based trainings, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

A “computing device” refers to a computer, a device (that includes one or more processors/microcontrollers and/or any other electronic components), or a system (that performs one or more operations according to one or more sets of programming instructions, codes, or algorithms) associated with an individual (e.g., an employer, an employee, and/or the like). In an embodiment, the individual may utilize the computing device to perform one or more operations. For example, an individual, such as a staffing manager, may utilize the computing device to staff one or more employees on one or more projects. In another illustrative example, an individual, such as an employee, may utilize the computing device to perform a task associated with the one or more projects. Examples of the user-computing device may include, but are not limited to, a desktop computer, a laptop, a personal digital assistant (PDA), a mobile device, a smartphone, and a tablet computer (e.g., iPad® and Samsung Galaxy Tab®).

A “project” refers to a piece of work, an activity, an action, a job, an instruction, or an assignment to be performed. The project may necessitate the involvement of one or more employees with one or more specific skills to work upon the project. Examples of projects include, but are not limited to, digitizing a document, generating a report, evaluating a document, conducting a survey, writing a code, extracting data, and/or translating text.

An “employee” refers to a worker(s) who may perform one or more tasks, which generate data that contribute to a defined result, for example, proofreading a part of a digital version of an ancient text or analyzing a quantum of a large volume of data. In an embodiment, the employee may be the workers(s) associated with an organization who possesses one or more skills that may be required to perform the one or more tasks.

A “training” refers to imparting knowledge or skills pertaining to a particular domain of study such as, but not limited to, science, mathematics, art, literature, language, philosophy, and so on.

An “organization” refers to an entity comprising a group of individuals engaged in a business of selling, renting, or sharing one or more products or services to one or more other organizations or individuals.

“One or more skills” refer to one or more abilities of an individual (e.g., an employee) that may be required to work upon a project. In an embodiment, the skills of the employee may be classified as, but not limited to, managerial skills, engineering skills, and/or research skills.

A “proficiency” of an employee refers to a level of skillfulness of the employee in one or more skills that may have been developed over a period of time, such as during an academic career and/or professional career. In an embodiment, the proficiency of the employee may be determined based on an evaluation of one or more tasks performed by the employee in the past. Further, in an embodiment, the proficiency may be determined based on a number (or types) of errors made by the employee in the past. Further, in an embodiment, the proficiency may be determined based on training goals of the employee. For example, the various proficiency levels may include a “beginner” level, an “intermediate” level, and an “advanced” level. Further, various sub-levels may exist between the two subsequent proficiency levels. For instance, there may be one or more sub-levels between the proficiency levels “beginner” and “intermediate.” The individual may traverse through each of the one or more sub-levels to graduate from the “beginner” level to the “intermediate” level of expertise.

A “proficiency gap” refers to a gap between a desired proficiency in one or more skills required for a project and an acquired proficiency in the one or more skills possessed by an employee. In an embodiment, the desired proficiency in a skill corresponds to a minimum proficiency level in the skill that one or more employees must possess to work upon a task or a project in an organization. In an embodiment, the acquired proficiency in the skill corresponds to a maximum proficiency level that is currently possessed by the one or more employees in the organization.

A “user interface (UI)” refers to an interface or a platform that may facilitate a user to interact with an associated computing device, such as a computer, a laptop, or a smartphone. The user may utilize various input mediums to interact with the UI such as, but not limited to, a keypad, mouse, joystick, any touch-sensitive medium (e.g., a touch-screen or touch sensitive pad), voice recognition, gestures, video recognition, and so forth.

“Ontology” refers to an interrelationship of one or more resources (e.g., employees) and their related one or more attributes. In an embodiment, the ontology model may represent the interrelationship between one or more roles in one or more projects, one or more skills required by the one or more roles, one or more trainings available on the one or more skills, and a proficiency of each of one or more employees on the one or more skills.

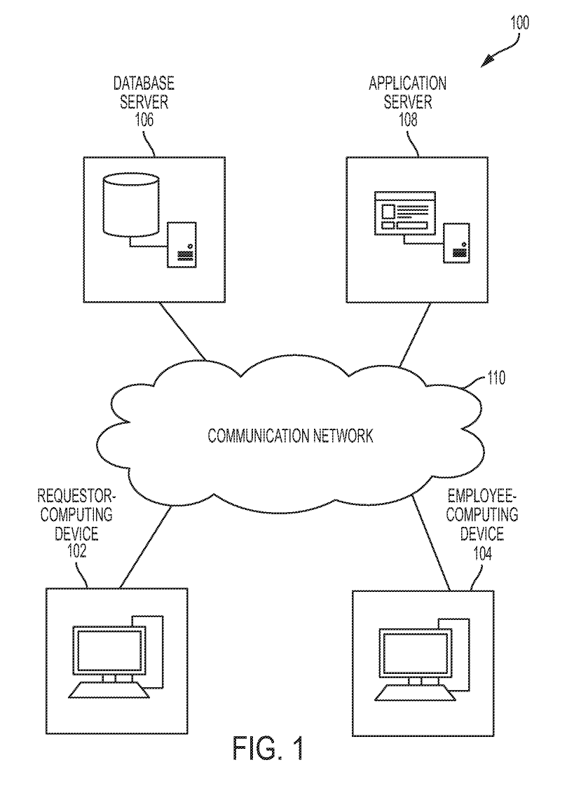

FIG. 1 is a block diagram that illustrates a system environment in which various embodiments of a method and a system may be implemented. With reference to FIG. 1, there is shown a system environment 100 that includes a requestor-computing device 102, an employee-computing device 104, a database server 106, and an application server 108 that are connected over a communication network 110. FIG. 1 shows, for simplicity, one requestor-computing device, such as the requestor-computing device 102, one employee-computing device, such as the employee-computing device 104, one database server, such as the database server 106, and one application server, such as the application server 108. However, it will be apparent to a person having ordinary skills in the art that the disclosed embodiments may also be implemented using multiple requestor-computing devices, multiple employee-computing devices, multiple database servers, and multiple applications servers, without deviating from the scope of the disclosure.

The requestor-computing device 102 may refer to a computing device (associated with a requestor) that may be communicatively coupled to the communication network 110. The requestor may correspond to an individual, such as a project manager, a staffing manager, a human resource manager, an administrator, and/or the like, who may utilize the requestor-computing device 102 to staff one or more employees one or more projects. The requestor-computing device 102 may comprise one or more processors in communication with one or more memory units. Further, in an embodiment, the one or more processors may be operable to execute one or more sets of computer readable codes, instructions, programs, or algorithms, stored in the one or more memory units, to perform one or more associated operations.

In an embodiment, the requestor may utilize the requestor-computing device 102 to initiate an auto-selection of the one or more employees for one or more trainings. The one or more trainings may be associated with one or more skills that are required for one or more roles in a project. The requestor may further utilize the requestor-computing device 102 to transmit a request to the database server 106 or the application server 108 over the communication network 110. The request may comprise the one or more skills that are required to work upon the project. The request may further comprise a first proficiency score for each of the one or more required skills that are required for the one or more roles in the project. In an embodiment, the requestor may define the first proficiency score for each of the one or more required skills. Further, the requestor may utilize the requestor-computing device 102 to view a list of employees who may have been selected for the one or more trainings. Further, the requestor may utilize the requestor-computing device 102 to view post performance trainings of the one or more employees that are in the selected list of employees. Further, in an embodiment, the requestor may utilize the requestor-computing device 102 to add or remove one or more employees to or from the list of employees based on at least his/her preferences.

Examples of the requestor-computing device 102 may include, but are not limited to, a personal computer, a laptop, a personal digital assistant (PDA), a mobile device, a tablet, or any other computing device.

The employee-computing device 104 may refer to a computing device (associated with an employee) that may be communicatively coupled to the communication network 110. The employee may correspond to an individual, possessing the one or more skills, who may work upon the project that has been assigned or allocated to him/her. The employee-computing device 104 may comprise one or more processors in communication with one or more memory units. Further, in an embodiment, the one or more processors may be operable to execute one or more sets of computer readable codes, instructions, programs, or algorithms, stored in the one or more memory units, to perform one or more associated operations. In an embodiment, the employee may utilize the employee-computing device 104 to view a schedule of one or more skill-based trainings that may have been assigned to him/her. In an embodiment, the employee may utilize the employee-computing device 104 to accept or reject the one or more skill-based trainings based on his/her availability or preferences.

Examples of the employee-computing device 104 may include, but are not limited to, a personal computer, a laptop, a personal digital assistant (PDA), a mobile device, a tablet, or any other computing device.

The database server 106 may refer to a computing device that may be communicatively coupled to the communication network 110. In an embodiment, the database server 106 may be configured to perform one or more database operations. The one or more database operations may include one or more of, but are not limited to, receiving, storing, processing, and transmitting one or more queries, request, data, or content to/from one or more computing devices. For example, the database server 106 may be configured to store one or more requests and associated information received from the requestor-computing device 102. The database server 106 may further be configured to store one or more attributes of the one or more employees in the organization. For example, one or more attributes of an employee may include, but are not limited to, a name of the employee, an employee id, one or more current skills of the employee and a second proficiency score in each of the one or more current skills.

Additionally, the database server 106 may further be configured to store historical data of the one or more employees. The historical data may include a performance of the one or more employees on one or more previous projects, an experience of the one or more employees in the one or more current skills, and a service duration of the one or more employees in the organization.

Further, in an embodiment, the database server 106 may store one or more sets of instructions, codes, scripts, or programs that may be retrieved by the application server 108 to perform one or more operations. For querying the database server 106, one or more querying languages may be utilized, such as, but not limited to, SQL, QUEL, and DMX. In an embodiment, the database server 106 may be realized through various technologies such as, but not limited to, Microsoft® SQL Server, Oracle®, IBM DB2®, Microsoft Access®, PostgreSQL®, MySQL® and SQLite®, and the like.

The application server 108 may refer to a computing device or a software framework hosting an application or a software service that may be communicatively coupled to the communication network 110. In an embodiment, the application server 108 may be implemented to execute procedures such as, but not limited to, the one or more sets of programs, instructions, codes, routines, or scripts stored in one or more memory units for supporting the hosted application or the software service. In an embodiment, the hosted application or the software service may be configured to perform the one or more operations.

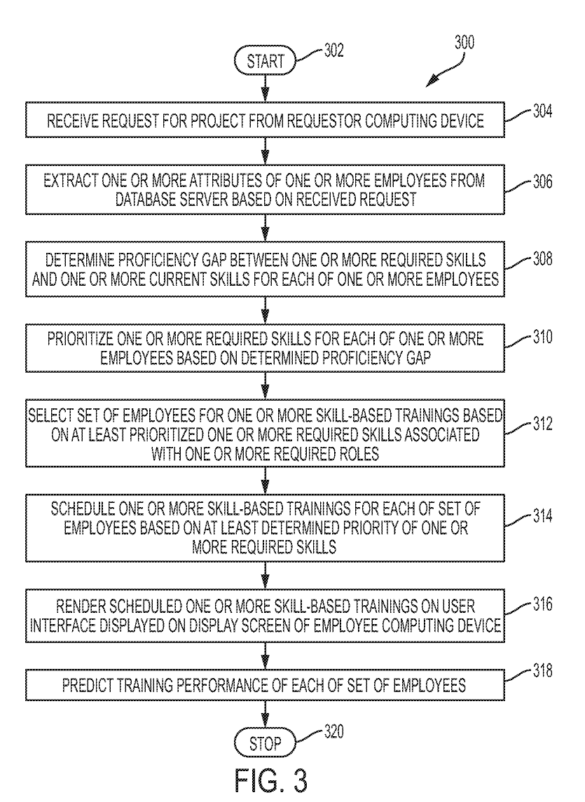

In an embodiment, the application server 108 may be operable to receive the request from the requestor-computing device 102 over the communication network 110. The request may correspond to the role-based auto-selection of employees for trainings associated with skills required in a project. The request may comprise the one or more required skills for the required role in the project and the first proficiency score for each of the one or more required skills. Further, the application server 108 may be configured to extract the one or more attributes of the one or more employees from the database server 106 based on the received request. The one or more attributes may include one or more of, but are not limited to, an employee name, an employee id, one or more current skills of the employee and a second proficiency score in each of the one or more current skills. Further, in an embodiment, the application server 108 may be configured to determine a proficiency gap, between the one or more required skills and the one or more current skills, for each of the one or more employees. The proficiency gap is determined based on historical data associated with each of the one or more employees. Thereafter, the application server 108 may be configured to prioritize the one or more required skills for each of the one or more employees based on the determined proficiency gap. Further, in an embodiment, the application server 108 may be configured to select a set of employees, from the one or more employees, for one or more skill-based trainings based on at least a comparison of the determined proficiency gap with a threshold value. In an embodiment, the requestor may define the threshold value. In another embodiment, the application server 108 may determine the threshold value based on the historical data of the one or more employees. The selection of the set of employees has been explained in detail in conjunction with FIG. 3.

Further, in an embodiment, the application server 108 may be configured to schedule the one or more skill-based trainings, associated with the one or more required skills, for each of the set of employees based on at least the determined priority of the one or more required skills. Further, in an embodiment, the application server 108 may be configured to render the scheduled one or more skill-based trainings on a user interface displayed on a display screen of the employee-computing device 104 associated with each of the set of employees.

The application server 108 may further be configured to determine training data based on at least a historical performance of each of the set of employees in the one or more current skills and an experience of each of the set of employees in the one or more current skills. The training data is further utilized to train a predictive model. The predictive model is utilized to predict a performance of each of the set of employees corresponding to the one or more skill-based trainings. The post training performance of each of the set of employees has been explained in detail in conjunction with FIG. 3.

The application server 108 may be realized through various types of application servers such as, but are not limited to, a Java application server, a .NET framework application server, a Base4 application server, a PHP framework application server, or any other application server framework.

A person with ordinary skill in the art will understand that the scope of the disclosure is not limited to the database server 106 or the application server 108 as a separate entity. In an embodiment, the functionalities of the database server 106 may be integrated into the application server 108, or vice-versa.

In an embodiment, the communication network 110 may correspond to a medium through which the request or content (such as one or more attributes of the one or more employees) may flow between the requestor-computing device 102, the employee-computing device 104, the database server 106, and the application server 108. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 110 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

A person with ordinary skills in the art will appreciate that the scope of the disclosure is not limited to realizing the application server 108 and the requestor-computing device 102 as separate entities. In an embodiment, the application server 108 may be realized as an application program installed on and/or running on the requestor-computing device 102 without departing from the scope of the disclosure.

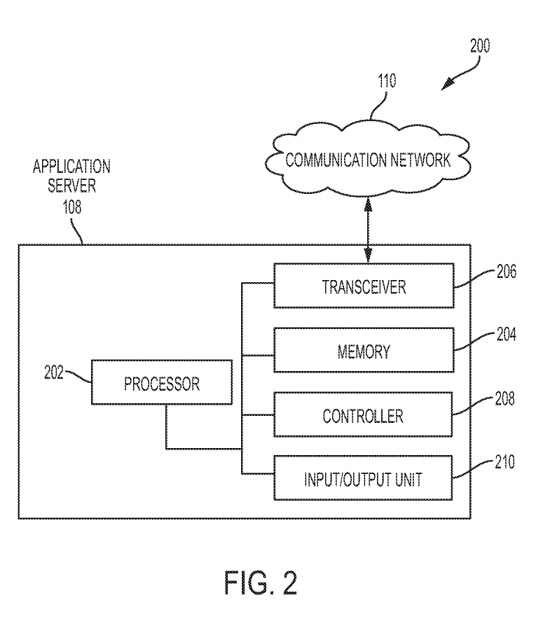

FIG. 2 is a block diagram that illustrates a system for the role-based auto-selection of employees for trainings associated with skills required in the project, in accordance with at least one embodiment. With reference to FIG. 2, there is shown a system 200 that may include one or more processors, such as a processor 202, one or more memory units, such as a memory 204, one or more transceivers, such as a transceiver 206, one or more controllers, such as a controller 208, and one or more input/output units, such as an input/output (I/O) unit 210.

The system 200 may correspond to a computing server, such as the application server 108, or a computing device, such as the requestor-computing device 102, without departing from the scope of the disclosure. However, for the purpose of the ongoing description, the system 200 corresponds to the application server 108.

The processor 202 comprises suitable logic, circuitries, interfaces, and/or codes that may be configured to execute one or more set of instructions, programs, or algorithms stored in the memory 204. The processor 202 may be communicatively coupled to the memory 204, the transceiver 206, the controller 208, and the I/O unit 210. The transceiver 206 may be communicatively coupled to the communication network 110. The processor 202 may be implemented based on a number of processor technologies known in the art. The processor 202 may work in coordination with the transceiver 206, the controller 208, and the I/O unit 210 to select the set of employees for the one or more skill-based trainings associated with the one or more skills required for the one or more roles in the project. Examples of the processor 202 include, but are not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may be operable to store one or more machine codes, and/or computer programs having at least one code section executable by the processor 202. The memory 204 may store one or more sets of instructions, programs, codes, or algorithms that may be executed by the processor 202 to perform the one or more operations of the application server 108. Further, the memory 204 may include one or more buffers (not shown) that may be configured to store information such as the request, the one or more attributes of the one or more employees, past performances of the one or more employees, and/or the like. Some of the commonly known memory implementations include, but are not limited to, a random access memory (RAM), a read-only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 comprises suitable logic, circuitries, interfaces, and/or codes that may be configured to receive or transmit the one or more queries, data, content, or other information to/from one or more computing devices (e.g., the database server 106 or the requestor-computing device 102) over the communication network 110. The transceiver 206 may implement one or more known technologies to support wired or wireless communication with the communication network 110. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The controller 208 comprises suitable logic, circuitries, interfaces, and/or codes that may be configured to at least control or regulate various operations between one or more internal components of the application server 108. The controller 208 may be communicatively coupled to the processor 202, the memory 204, the transceiver 206, and the I/O unit 210. The controller 208 may be a plug in board, a single integrated circuit on the motherboard, or an external device. Examples of the controller 208 include, but are not limited to, graphics controller, SCSI controller, network interface controller, memory controller, programmable interrupt controller, and/or terminal access controller.

The I/O unit 210 may comprise suitable logic, circuitries, interfaces, and/or codes that may be operable to receive one or more requests or queries from the requestor-computing device 102. Further, the I/O unit 210 in conjunction with the transceiver 206 may be configured to transmit one or more responses pertaining to the one or more requests or queries to the database server 106 or the requestor-computing device 102 via the communication network 110. The I/O unit 210 may be operable to communicate with the processor 202, the memory 204, the transceiver 206, or the controller 208. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and/or a display screen.

FIG. 3 is a flowchart that illustrates a method for the role-based auto-selection of employees for trainings associated with skills required in the project, in accordance with an embodiment. With reference to FIG. 3, there is shown a flowchart 300 that is described in conjunction with FIG. 1 and FIG. 2. The method starts at step 302 and proceeds to step 304.

At step 304, the request for the project is received from the requestor-computing device 102. The request may comprise information pertaining to the selection of a set of employees from the one or more employees in the organization. The set of employees may be selected for the one or more skill-based trainings associated with the one or more required skills for the required role in the project. In an embodiment, the transceiver 206 may be configured to receive the request for the project from the requestor-computing device 102 over the communication network 110. The request may further comprise the associated information such as, but not limited to, a type of the project, the one or more required skills for the required role in the project, and the first proficiency score for each of the one or more required skills. After receiving the request from the requestor-computing device 102, the transceiver 206 may store the request in a storage device, such as the database server 106 or the memory 204.

At step 306, the one or more attributes of the one or more employees are extracted from the database server 106 based on the received request. In an embodiment, the processor 202 may be configured to extract the one or more attributes of the one or more employees from the database server 106 based on the received request. For example, after receiving the request pertaining to the selection of the one or more employees, the processor 202 may transmit one or more queries to the database server 106 to extract the one or more attributes of the one or more employees. The one or more queries may be based on at least the one or more required skills and/or the required role in the project. Based on the transmitted one or more queries, the processor 202 may extract the one or more attributes of the one or more employees, who are associated with at least one of the one or more required skills and/or the required role. For example, the one or more attributes of an employee may include, but are not limited to, a name, an employee identification number, one or more current skills of the employee, and a second proficiency score in each of the one or more current skills. Thereafter, the processor 202 may store the extracted one or more attributes of the one or more employees in the memory 204.

Prior to the extraction of the one or more attributes, in an embodiment, the processor 202 may be operable to identify the one or more employees from all the employees of the organization, who may possess at least one of the one or more required skills and/or are associated with the required role. In order to do so, the processor 202 may be operable to determine the one or more current skills of all the employees for each role in the organization. For example, the processor 202, for a given role, may utilize at least one or more feature selection techniques to determine the one or more current skills of the one or more employees. In an illustrative scenario, the processor 202 may execute the following algorithm to determine the one or more current skills of all the employees based on an ontology of employees managed by the organization.

For a role r in a project p such that:

∀rεrole,pεOrganizationCollaboration,

a set of required skills S(r,p) may be expressed as:

S(r,p)≡{s|∀_{cεcapability,tεTask},∃requireRoles(p,r)∩haveTasks(r,t)∩requireCapability(t,c)∩haveSkill(c,s)}

Further, for the role r in the project p such that:

∀rεrole,pεOrganizationCollaboration,

a working set of employees, E(r,p), may be expressed as:

E(r,p)≡{e|∀_{mεmembership},∃hasMember(e,m)∩role(m,r)∩requiresRoles(p,r)}.

Furthermore, for the role r in the project p such that:

∀rεrole,pεOrganizationCollaboration

a set that contains the proficiency level performances (i.e., the first proficiency scores), PLP(r,p), on the required skills S(r,p) and the performance (PER), for a working employee, may be expressed as:

PLP(r,p)≡{<l₁,l₂,ln>,PER},

where,

lᵢ(sᵢ)=sᵢεS(r,p),haveCapabilities(e,c)∩haveSkill(c,sᵢ)∩hasLevel(c,lᵢ), and

∀eεAgent,rεRole,pεOrganizationCollaboration,

PER(e,r,j)≡{p|hasPerformance(e,p)·forRole(p,r)∩requiresRole(r,p)}

After determining the one or more current skills and/or the current role of all the employees in the organization, the processor 202 may select the one or more employees based on at least a comparison of the one or more required skills and/or the required role with the one or more current skills and/or the current role of all the employees in the organization. Thereafter, the processor 202 may extract the one or more attributes of the one or more employees from the database server 106.

At step 308, the proficiency gap between the one or more required skills and the one or more current skills for each of the one or more employees is determined. In an embodiment, the processor 202 may be configured to determine the proficiency gap between the one or more required skills and the one or more current skills for each of the one or more employees. In an embodiment, the processor 202 may determine the proficiency gap for each of the one or more employees based on at least the historical data associated with each of the one or more employees.

In an embodiment, the processor 202 may be configured to determine the proficiency gap based on the first proficiency score and the second proficiency score. The first proficiency score may correspond to a proficiency level required for each of the one or more required skills. The second proficiency score may correspond to a proficiency level that may have been achieved by each of the one or more employees in their corresponding one or more current skills.

In an embodiment, the processor 202 may determine the first proficiency score of each of the one or more required skills based on the request received from the requestor-computing device 102. Further, in an embodiment, the processor 202 may determine the second proficiency score of each of the one or more current skills based on the historical data associated with the one or more employees. For example, the processor 202 may determine the second proficiency score of an employee, “XYZ,” for a current skill, “ABC,” based on the historical performance of the employee “XYZ.” The employee “XYZ” may have utilized the current skill “ABC” to work upon one or more previous projects that were assigned to him/her. Based on at least a quality delivered and one or more service level agreements (SLAs) met by the employee “XYZ” while working on the one or more previous projects, the processor 202 may determine the second proficiency score of the employee “XYZ.”

After determining the first proficiency score and the second proficiency score, the processor 202 may determine the proficiency gap. For example, the proficiency gap may correspond to a difference between the first proficiency score and the second proficiency score, such that the first proficiency score and the second proficiency score are associated with the same skill. For example, the employee “XYZ” possesses one or more current skills, such as “XA,” “YA,” and “ZA,” and a second proficiency score associated with each of the one or more current skills are “0.2,” “0.5,” and “0.7,” respectively. A request for a new project is received, which may require the one or more required skills that are same as the one or more current skills of the employee “XYZ,” i.e., “XA,” “YA,” and “ZA.” A proficiency score of each of the one or more required skills are “0.4,” “0.5,” and “0.8,” respectively. In such a scenario, the processor 202 may determine the proficiency gap for the skill “XA” as “0.2.” Similarly, the processor 202 may determine the proficiency gap for the skill “YA” as “0,” and the proficiency gap for the skill “ZA” as “0.1.”

At step 310, the one or more required skills for each of the one or more employees are prioritized based on the determined proficiency gap. In an embodiment, the processor 202 may be configured to prioritize the one or more required skills for each of the one or more employees based on the determined proficiency gap for each of the one or more required skills. In an embodiment, the processor 202 may prioritize the one or more required skills when the proficiency gap between the one or more required skills and the one or more current skills is greater than a threshold value. In an embodiment, the processor 202 may determine the threshold value based on the historical data of each of the one or more employees. The historical data may include, but is not limited to, a historical performance of each of the one or more employees, a historical learning of each of the one or more employees, a historical success of each of the one or more employees based on at least an implementation of the historical learning, and so on.

With respect to the ongoing example, as discussed above in step 308, the proficiency gaps determined for the skills “XA,” “YA,” and “ZA” are “0.2,” “0,” and “0.1,” respectively. Let us assume that the threshold value is “0.05.” In such a case, the proficiency gap of the employee “XYZ” in the skill “XA” is greater than the threshold value, i.e., “0.2”>“0.05.” However, the proficiency gap of the employee “XYZ” in the skill “YA” is less than the threshold value, i.e., “0”<“0.05.” Similarly, the proficiency gap of the employee “XYZ” in the skill “ZA” is greater than the threshold value, i.e., “0.1”>“0.05.” In such a scenario, the processor 202 may prioritize the one or more required skills based on the determined proficiency gap, such that the determined proficiency gap is greater than the threshold value. With respect to the ongoing example, the processor 202 may assign a first priority to the required skill “XA” and a second priority to the required skill “ZA.” Similarly, the processor 202 may prioritize the one or more required skills for each of the remaining one or more employees.

At step 312, the set of employees is selected from the one or more employees based on at least the prioritized one or more required skills determined for each of the one or more employees. In an embodiment, the processor 202 may be configured to select the set of employees from the one or more employees based on at least the prioritized one or more required skills determined for each of the one or more employees. In an embodiment, the processor 202 may select the set of employees for each of the one or more required skills. In an embodiment, the processor 202 may determine a count of employees for each of the one or more required skills based on the received request provided by the requestor.

For example, consider a scenario where a project requires two employees for each skill (e.g., “Skill-A,” “Skill-B,” and “Skill-C”) for a required role in an organization. The proficiency gap of employees (e.g., “Employee-A,” “Employee-B,” and “Employee-C”) for each of the skills in the project is shown in Table-1.

TABLE 1
Illustrative example depicting proficiency gap of
employees in various skills

| | Proficiency gap | Proficiency gap | Proficiency gap |
|---|---|---|---|
| | of Employee-A | of Employee-B | of Employee-C |
| Skill-A | 0.5 | 0.7 | 0.9 |
| Skill-B | 0.45 | 0.35 | 0.25 |
| Skill-C | 0.2 | 0.3 | 0.2 |

For a required skill, such as the “Skill-A,” the processor 202 may select the two employees from the three employees based on the proficiency gaps in the “Skill-A.” As shown in Table-1, the proficiency gap of the employees, such as “Employee-A” and “Employee-B” are “0.5” and “0.7,” respectively, which are less than the proficiency gap of the employee, such as the “Employee-C.” Therefore, the processor 202 may select two employees, such as “Employee-A” and “Employee-B,” for a training associated with the “Skill-A.” Similarly, for a required skill, such as the “Skill-B,” the processor 202 may select two employees, such as “Employee-B” and “Employee-C” for a training associated with the “Skill-B.” Similarly, for a required skill, such as the “Skill-C,” the processor 202 may select two employees, such as “Employee-A” and “Employee-C” for a training associated with the “Skill-C.”

At step 314, the one or more skill-based trainings associated with the one or more required skills are scheduled for each of the set of employees based on at least determined priority of the one or more required skills. In an embodiment, the processor 202 may be configured to schedule the one or more skill-based trainings, associated with the one or more required skills, for each of the set of employees based on at least the determined priority of the one or more required skills.

In an embodiment, the one or more skill-based trainings may be scheduled to eliminate a deficiency in the one or more required skills of each of the set of employees. For example, an employee may be selected for multiple skill trainings for proper project implementation. Further, in an embodiment, the one or more skill-based trainings may be scheduled periodically. The periodic scheduling of the one or more skill-based trainings may be based on at least one of, but not limited to, a current schedule of the one or more selected set of employees and/or a business requirement in the organization.

At step 316, the scheduled one or more skill-based trainings are rendered on a UI displayed on a display screen of the employee-computing device 104. In an embodiment, the processor 202 may be configured to render the scheduled one or more skill-based trainings on the UI displayed on the display screen of the employee-computing device 104.

In an embodiment, the organization may render the scheduled one or more skill-based trainings to the one or more selected set of employees in an online mode. For example, in an organization, people may be employed across the globe. The processor 202 may render the scheduled one or more skill-based trainings to the one or more selected set of employees in the online mode by use of various methodologies, such as a virtual classroom teaching methodology.

In another embodiment, the organization may render the scheduled one or more skill-based trainings to the one or more selected set of employees in an offline mode. For example, the processor 202 may share the content of the scheduled one or more skill-based trainings with the one or more selected set of employees, and thereafter, an employee may utilize the shared training content for acquiring the required proficiency level.

At step 318, the post-training performance of each of the one or more selected set of employees is predicted. In an embodiment, the processor 202 may be configured to predict the post-training performance of each of the one or more selected sets of employees.

In an embodiment, the processor 202 may be configured to train a predictive model, such as one or more classifiers, to predict the post-training performance of the one or more selected sets of employees. Prior to the training of the predictive model, the processor 202 may be configured to determine the training data that is utilized to train the predictive model. For example, the training data may be determined based on the historical performance of each of the one or more selected sets of employees in the one or more current skills, the experience of each of the one or more selected sets of employees in the one or more current skills, and the service duration of each of the one or more selected sets of employees in the organization. The training data may further include performance improvement data after each of the one or more selected sets of employees may have undergone one or more previous trainings.

The processor 202 may further utilize profile-related information about the one or more selected sets of employees to train the predictive model. The profile-related information may comprise various information, such as experience in the current organization, past job experiences, one or more acquired skillsets, one or more achievements, and one or more performance scores in other one or more professional activities.

Further, the predictive model may predict the effect of the profile-related information on the percentage change in an average processing time for the employee. The average processing time for the employee on the task may be measured for a configurable time interval (for example, one month) before and after the training and the employees may complete a minimum threshold of tasks, such as “10 tasks,” for the role during the period before and after the training and further this data may be used to predict the performance of other employees by creating a decision tree.

In an exemplary scenario, the processor 202 may develop a prediction model based on historical data of one or more employees, using a decision tree. The processor 202 may utilize one or more rule based learning models (e.g., a decision tree) to predict an employee's performance in one or more skills in one or more projects. Further, the decision tree may be built on required qualifications (in terms of skills) that the employee may possess to work upon the project. The decision tree takes as its input training data represented by a set proficiency level performance (PLP). Based on the performance value, the performance of the employee may be classified into three buckets, such as, but not limited to, a low performance bucket, an average performance bucket, and an excellent performance bucket. The threshold values, to classify the performance, may be provided as configuration values while building the decision tree. Once the decision tree is trained using the existing data about the skill proficiency levels and the performance of the one or more employees on a role in a project then it may be used to predict the performance of one or more new employees for the role in the project. Further, the decision tree may be used to identify the skill shortcomings of one or more existing employees who are not able to achieve a desired performance level defined by the organization.

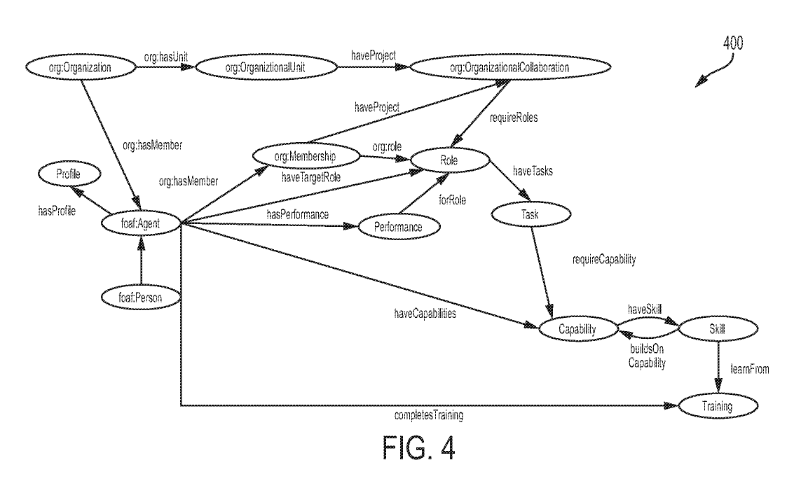

FIG. 4 is a graphical representation that illustrates ontology of an organization, in accordance with at least one embodiment. The ontology may be representative of at least an association of the one or more employees in the organization with at least one of one or more skills and one or more roles in the organization. With reference to FIG. 4, there is shown a graphical representation 400 that has been described in conjunction with FIG. 1, FIG. 2, and FIG. 3.

In an embodiment, the processor 202 may be configured to generate the ontology of an organization. The ontology may capture a semantic relationship between different data items that may be used for role-based auto-selection of the one or more employees for trainings associated with one or more skills required in a project. Further, the ontology may be used for resource allocation in the organization based on the one or more current skills of the one or more employees and the one or more skills required in the project. Further, the ontology may be used for generating one or more models for creating the proficiency of employee skills and predicting post-training performance. In an embodiment the ontology model may capture the relationship between at least a plurality of data items, such as, but not limited to, one or more skills being practiced by the organization, the one or more employees, the one or more current skills associated with the one or more roles of the one or more employees, a detailed profile associated with each of the one or more employees, one or more required skills associated with one or more future projects, one or more ongoing projects, one or more trainings pertaining to the one or more skills being practiced by the organization, and the one or more required skills.

With reference to FIG. 4, a department may be represented by a class “org:OrganizationalCollaboration” and a project may be represented by class “org:OrganizationalUnit” in the organization ontology. A class “org:Membership” may include a class “time:lnterval” during which the employee may be associated with the class “org:Role.” An employee, from the one or more employees, may be represented using a class “foaf:Person.” A class “foaf:Person” may be a type of class “foaf:Agent” and the employment relationship between the employee and the organization may be represented using a class “org:Membership,” which may capture an n-array relationship between the classes “foaf:Agent” and “org:Role.”

Further, the ontology model may extend the class “org:Role” by associating it with a collection of tasks, such as one or more assigned/upcoming projects, which the employee (represented as class “foaf:Agent”) assigned to the class “org:Role” may be expected to perform. The class “task” may include a duration data property, which may capture the time for which the employee may be asked to perform the task. Further, to perform the task, the employee may require skills represented by the class “skill.” The ontology model may capture the n-array relationship between the task, the skill, and the skill level that may be required to perform the task, and the required experience in the skill through the class “capability.” The class “capability” may be associated with a level property that may be accessed using level relationship. For every agent, a component of performance may also be added to the ontology model, which may capture the relationship between the employee's performance and the role in consideration.

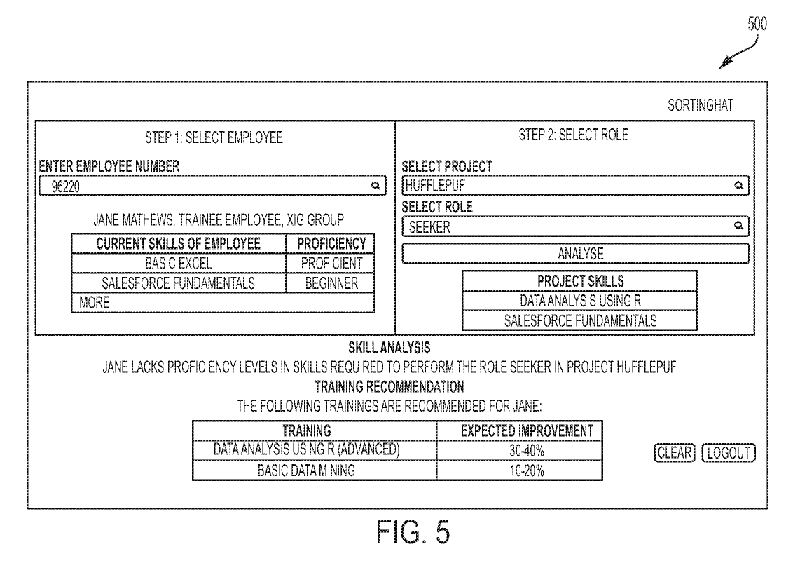

FIG. 5 is a block diagram that illustrates an exemplary GUI rendered on the requestor-computing device 102 for role-based auto-selection of employees for trainings associated with skills required in a project, in accordance with at least one embodiment. With reference to FIG. 5, there is shown an exemplary GUI that has been explained in conjunction with FIGS. 1-3.

In an embodiment, the GUI 500 may be displayed on the screen of the requestor-computing device 102 associated with a requestor, such as a staffing manager, who may want to select one or more employees for one or more skill-based trainings associated with one or more skills required for a role in a project. Prior to the rendering of the GUI 500 on the display screen, the requestor may utilize the requestor-computing device 102 to login (using user identifier and password) to an organization portal, such as a resource management portal. The resource management portal may facilitate the requestor for role-based auto-selection of the one or more employees for the one or more skill-based trainings associated with the one or more skills required for the role in the project. Based on validation of the login credentials, the processor 202 may render the GUI 500 on the display screen of the requestor-computing device 102 associated with the requestor.

In an embodiment, the rendered GUI 500 may comprise a window “Select employee.” The window “Select employee” may comprise a tab, such as “Enter employee number” tab. The requestor may click on the “Enter employee number” tab to input an employee number of an employee associated with the organization, and thereafter may click on a search icon. Based on the requested search, the processor 202 may display a name of the employee, a working department of the employee, a current project on which the employee may be staffed, one or more current skills and a corresponding proficiency level of the employee.

Further, in an embodiment, the rendered GUI 500 may comprise a window “Select role.” The requestor may click on a tab, such as a “Select Project” tab, to select a name of a project (e.g., “HufflePuf”). The requestor may further click on a tab, such as a “Select Role” tab, to select a role (e.g., “Seeker”) associated with the project. Based on the selection, the processor 202 may display one or more skills that are required for the role in the project. Thereafter, the requestor may provide an input by clicking on a tab, such as an “Analyze” tab, to initiate the analysis. Thereafter, the processor 202 may analyze the one or more current skills of the employee and the one or more required skills for the role in the project. Based on the analysis, the processor 202 may display one or more training recommendations on the display screen of the requestor-computing device 102 through the GUI 500. The processor 202 may further display an expected post-training performance of the employee in the one or more required skills in which the employee may lack a required proficiency level.

Various embodiments of the disclosure encompass numerous advantages including a method and a system to auto-select the role-based employees for one or more skill-based trainings associated with one or more skills that are required for a role in a project. The disclosure proposes the system and the method that can be used by an organization to select one or more employees for one or more skill-based trainings so that their performance may meet one or more levels as expected for the role in the project. The disclosed system may assist a manager to assess the one or more skills required for the role, determining knowledge gaps (i.e., proficiency gaps) of an employee trying to fill that role, and identifying the one or more skill-based trainings required to close the knowledge gap. The disclosed system may further provide an estimate of a performance improvement that is achievable once the required one or more skill-based trainings are completed by the employee.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be an HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for role-based auto-selection of employees for trainings associated with skills required in a project have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for role-based auto-selection of employees for trainings associated with skills required in a project, the method comprising:
receiving, by one or more transceivers at a server, a request for the project from a requestor computing device over a communication network, wherein the request comprises at least one or more required skills for one or more required roles in the project;
extracting, by one or more processors at the server, one or more attributes of one or more employees from a database server based on the received request, wherein the one or more attributes comprise at least one or more current skills of the one or more employees;
for a required role in the project:
determining, by the one or more processors at the server, a proficiency gap between the one or more required skills and the one or more current skills for each of the one or more employees based on a historical data associated with said each of the one or more employees; and
prioritizing, by the one or more processors at the server, the one or more required skills for each of the one or more employees based on the determined proficiency gap; and
selecting, by the one or more processors at the server, a set of employees from the one or more employees for one or more skill-based trainings, associated with the one or more required skills, based on at least the prioritized one or more required skills associated with the one or more required roles.

2. The method of claim 1, wherein the request further comprises a first proficiency score for each of the one or more required skills for each of the one or more required roles in the project.

3. The method of claim 1, wherein the one or more attributes further comprise one or more current roles of the one or more employees, and a second proficiency score in each of the one or more current skills of the one or more employees.

4. The method of claim 1, wherein the proficiency gap between a required skill in the project and a current skill of an employee is determined, by the one or more processors, based on a first proficiency score associated with the required skill and a second proficiency score associated with the current skill.

5. The method of claim 1, wherein the one or more required skills are prioritized for each of the one or more employees, when the determined proficiency gap between each of the one or more required skills and each of the one or more current skills is greater than a threshold value; wherein the threshold value is determined based on the historical data of the each of the one or more employees.

6. The method of claim 5 further comprising scheduling, by the one or more processors, the one or more skill-based trainings, associated with the one or more required skills, for each of the set of employees based on at least the determined priority of the one or more required skills.

7. The method of claim 6 further comprising rendering, by the one or more processors, the scheduled one or more skill-based trainings on a user interface displayed on a display screen of an employee computing device associated with each of the set of employees.

8. The method of claim 7 further comprising determining, by the one or more processors, a training data based on at least a historical performance of each of the set of employees in the one or more current skills, an experience of each of the set of employees in the one or more current skills, and a service duration of each of the set of employees in an organization.

9. The method of claim 8 further comprising training, by the one or more processors, a predictive model based on the determined training data, wherein the trained predictive model is utilized to predict a performance of each of the set of employees corresponding to the one or more skill-based trainings.

10. A system for role-based auto-selection of employees for trainings associated with skills required in a project, the system comprising:
one or more transceivers at a server configured to receive a request for the project from a requestor computing device over a communication network, wherein the request comprises at least one or more required skills for one or more required roles in the project;
one or more processors at the server configured to:
extract one or more attributes of one or more employees from a database server based on the received request, wherein the one or more attributes comprise at least one or more current skills of the one or more employees;
for a required role in the project:
determine a proficiency gap between the one or more required skills and the one or more current skills for each of the one or more employees based on a historical data associated with said each of the one or more employees; and
prioritize the one or more required skills for each of the one or more employees based on the determined proficiency gap; and
select a set of employees from the one or more employees for one or more skill-based trainings, associated with the one or more required skills, based on at least the prioritized one or more required skills associated with the one or more required roles.

11. The system of claim 10, wherein the request further comprises a first proficiency score for each of the one or more required skills for each of the one or more required roles in the project.

12. The system of claim 10, wherein the one or more attributes further comprise one or more current roles of the one or more employees, and a second proficiency score in each of the one or more current skills of the one or more employees.

13. The system of claim 10, wherein the one or more processors are further configured to determine the proficiency gap between a required skill in the project and a current skill of an employee is determined, by the one or more processors, based on a first proficiency score associated with the required skill and a second proficiency score associated with the current skill.

14. The system of claim 10, wherein the one or more processors are further configured to prioritize for each of the one or more employees, when the determined proficiency gap between each of the one or more required skills and each of the one or more current skills is greater than a threshold value; wherein the threshold value is determined based on the historical data of the each of the one or more employees.

15. The system of claim 14, wherein the one or more processors are further configured to schedule the one or more skill-based trainings, associated with the one or more required skills, for each of the set of employees based on at least the determined priority of the one or more required skills.

16. The system of claim 15, wherein the one or more processors are further configured to render the scheduled one or more skill-based trainings on a user interface displayed on a display screen of an employee computing device associated with each of the set of employees.

17. The system of claim 16, wherein the one or more processors are further configured to determine a training data based on at least a historical performance of each of the set of employees in the one or more current skills, an experience of each of the set of employees in the one or more current skills, and a service duration of each of the set of employees in an organization.

18. The system of claim 17, wherein the one or more processors are further configured to train a predictive model based on the determined training data, wherein the trained predictive model is utilized to predict a performance of each of the set of employees corresponding to the one or more skill-based trainings.

19. A computer program product for use with a computer, the computer program product comprising a non-transitory computer readable medium, wherein the non-transitory computer readable medium stores a computer program code for role-based auto-selection of employees for trainings associated with skills required in a project, wherein the computer program code is executable by one or more processors at a server to:
receive a request for the project from a requestor computing device over a communication network, wherein the request comprises at least one or more required skills for one or more required roles in the project;
extract one or more attributes of one or more employees from a database server based on the received request, wherein the one or more attributes comprise at least one or more current skills of the one or more employees;
for a required role in the project:
determine a proficiency gap between the one or more required skills and the one or more current skills for each of the one or more employees based on a historical data associated with said each of the one or more employees; and
prioritize the one or more required skills for each of the one or more employees based on the determined proficiency gap; and
select a set of employees from the one or more employees for one or more skill-based trainings, associated with the one or more required skills, based on at least the prioritized one or more required skills associated with the one or more required roles.
